(19) United States
(12) Patent Application Publication
(10) Pub. No.: US 2012/0168459 A1
(43) Pub. Date: Jul. 5, 2012

(54) AUTOMATIC HEATED FLOWABLE SOAP DISPENSER

(76) Inventor: Patricia D'Onofrio, Dagsboro, DE (US)

(21) Appl. No.: 12/983,405

(22) Filed: Jan. 3, 2011

(51) Int. Cl. B67D 7/08; B67D 7/80

(52) U.S. Cl. 222/52; 222/54; 222/146.5

(57) ABSTRACT

In a flowable soap dispenser comprising an operable pump, a reservoir operatively connected to the pump means for supplying flowable soap to be dispensed to the pumping means, the improvement comprising a heater associated with the dispenser for heating the flowable soap prior to the dispensing thereof.

### BACKGROUND OF THE INVENTION

When one is away from their home or other familiar environment; e.g., travelling, eating out, etc., it is often necessary to wash one's hands. When using unfamiliar restrooms it is desirable to use warm water to more effectively disinfect one's hands and provide a more assured feeling of cleanliness. Moreover, warm water is more comfortable to the touch and provides a more pleasing washing experience.

Often, however, restrooms in commercial establishments are equipped with water dispensers which dispense only cold water; either upon manual operation of a faucet or upon sensing the presence of hands in the vicinity of an automatic water dispenser. Such systems are accompanied by manual or automatic flowable soap dispensers. The first delivers soap upon manually actuating a pump mechanism associated with a reservoir of flowable soap. The latter delivers a measured amount of soap much in the manner of the automatic water dispenser; i.e., when hands are sensed as being adjacent to the dispenser.

It is an object of the invention to provide a system that enables the user of restrooms such as described above to wash their hands at temperatures well above that of the cold water typically dispensed in such restrooms.

### BRIEF DESCRIPTION OF THE INVENTION

The above and other objects are realized by the invention, one embodiment of which relates to an improved flowable soap dispenser for use in conjunction with a cold water dispenser, the flowable soap dispenser comprising an operable pumping means, a reservoir operatively connected to said pumping means for supplying flowable soap to be dispensed to said pumping means, the improvement comprising means associated with said dispenser for heating said flowable soap prior to the dispensing thereof.

### BRIEF DESCRIPTION OF THE DRAWING

FIG. 1 illustrates a schematic representation of the flowable soap heating system 10 according to an embodiment of the present invention.

### DETAILED DESCRIPTION OF THE INVENTION

Another embodiment of the invention is concerned with an improved flowable soap dispenser as described above, wherein the pumping means is manually operable.

A further embodiment of the invention relates to an improved flowable soap dispenser as described above, wherein the pumping means is electrically operable; i.e., by means of an electric motor.

An additional embodiment of the invention comprises an improved flowable soap dispenser as described above, wherein the pumping means is automatically operable.

A still further embodiment of the invention concerns an improved flowable soap dispenser as described above, wherein the pumping means is automatically operable and the dispenser includes an electric circuit for operating the soap dispenser, the electric circuit including a sensor means providing an operating signal in response to the presence of a person positioned to use the soap dispenser, an electric operator which, upon activation, causes the soap dispenser to automatically dispense a measured amount of soap, circuit means connecting the sensor means and the electric operator whereby an operating signal from the sensor will cause activation of the electric operator, the connecting circuit means including means for providing a pulse of predetermined duration for activation of the electric operator.

Those skilled in the art will appreciate that the invention embraces any system comprising a dispenser of flowable soap; i.e., a substance that continually deforms (flows) under an applied shear stress such as, for example, liquid, foamed or any other form of soap which obeys the laws and mechanics of fluids.

It will also be evident to the skilled artisan that the invention is not limited to any particular configuration of heater; i.e., that the invention includes any type of heating means associatable with a flowable soap dispenser that is capable of heating the flowable soap contained therein. For example, the heating element may comprise one or more conductive rods and/or coils such as exemplified in the drawing. This type of heating element is preferably configured to be electrically isolated from fluid, such as water, within a fluid receptacle through a calorimetric rod. The heating means is preferably incorporated in the reservoir which contains the flowable soap; however, those skilled in the art will appreciate that the heating means may occupy any position or location in or on the dispenser that will enable it to raise the temperature to a desired value.

Those skilled in the art will also appreciate that the invention also includes a flowable soap temperature regulating means which includes a temperature monitoring means and means responsive thereto for controlling the heating means to maintain the temperature of the flowable soap at a predetermined, desired level.

Those skilled in the art will also appreciate that the invention is applicable to any type of soap dispenser, whether manually, electrically or automatically operable. It should be well understood that the following examples of suitable dispensers should be construed as exemplary and not limiting, as the flowable soap dispenser may comprise any one of a number of existing, or yet to be developed such dispensers which contain a reservoir of flowable soap that may be periodically dispensed. See, for example, the dispensers described in U.S. Pat. Nos. 2,898,009; 4,722,372; 4,938,384; 4,946,070; 4,967,935; 5,105,992; 5,344,047; 5,507,413.

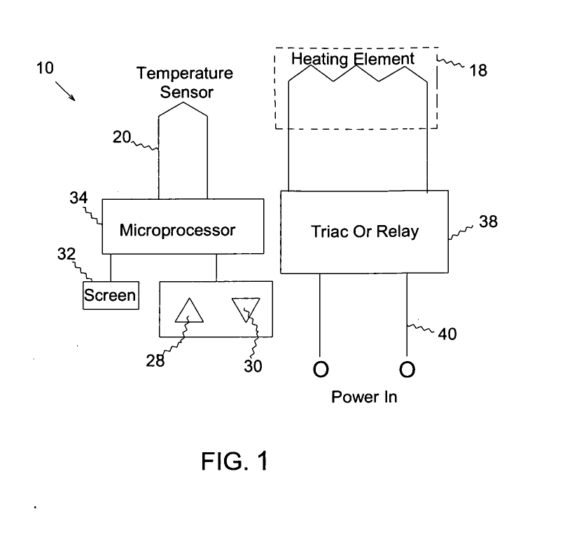

Referring to FIG. 1, the flowable soap heating system 10 includes a processing unit 34 (such as a microprocessor, microcontroller, an integrated circuit, such as an application specific integrate circuit (ASIC), or any other such electronic controller) electrically connected to the temperature sensor 20. The screen 32 and the adjustment buttons 28 and 30 are also in electrical communication with the processing unit 34.

The processing unit 34 is, in turn, electrically connected to the heating element 18. A power switch 38, such as a semiconductor switch (e.g., a triac) and/or relay may be disposed within the electrical path between the processing unit 34 and the heating element 18. A power source (not shown) is electrically connected to the switch 38. The processing unit 34 activates or deactivates the switch 38 in order to selectively energize/de-energize the heating element 18 depending on the temperature detected by the temperature sensor 20 and relayed to the processing unit 34.

1. In a flowable soap dispenser comprising an operable pumping means, a reservoir operatively connected to said pumping means for supplying flowable soap to be dispensed to said pumping means, the improvement comprising means associated with said dispenser for heating said flowable soap prior to the dispensing thereof.

2. The flowable soap dispenser of claim 1 wherein said pumping means is manually operable.

3. The flowable soap dispenser of claim 1 wherein said pumping means is automatically operable.

4. The automatically operable flowable soap dispenser of claim 3 comprising an electric circuit for operating said soap dispenser, said electric circuit including a sensor means providing an operating signal in response to the presence of a person positioned to use said soap dispenser, an electric operator which, upon activation, causes the soap dispenser to automatically dispense a measured amount of soap, circuit means connecting the sensor means and the electric operator whereby an operating signal from the sensor will cause activation of the electric operator, said connecting circuit means including means for providing a pulse of predetermined duration for activation of the electric operator.

5. The flowable soap dispenser of claim 1 wherein said flowable soap is a liquid.

6. The flowable soap dispenser of claim 1 wherein said flowable soap is foam.

7. The flowable soap dispenser of claim 1 also including a flowable soap temperature regulating means which includes a temperature monitoring means and means responsive thereto for controlling the heating means to maintain the temperature of the flowable soap at a predetermined, desired level.

8. The flowable soap dispenser of claim 1 wherein said heating means is associated with said reservoir for said flowable soap.

9. The flowable soap dispenser of claim 1 wherein the heating means comprises an electric heating element positioned within the reservoir for contact with said flowable soap.

10. The flowable soap dispenser of claim 9 wherein said heating element comprises at least one conductive rod and/or coil

11. The flowable soap dispenser of claim 9 wherein said conductive rod and/or coil is configured to be electrically isolated from fluid through a calorimetric rod.
